(19) United States
(12) Patent Application Publication
(10) Pub. No.: US 2015/0354782 A1
(43) Pub. Date: Dec. 10, 2015

(54) OPTICAL PART, REFLECTOR, LIGHT-EMITTING DEVICE, AND LIGHTING DEVICE

(71) Applicant: Sharp Kabushiki Kaisha, Osaka-shi, Osaka (JP)

(72) Inventors: Masahiro KONISHI, Osaka-shi (JP); Takashi NAKANISHI, Osaka-shi (JP); Hiroyuki NOKUBO, Osaka-shi (JP); Yuhsuke FUJITA, Osaka-shi (JP); Ippei YAMAGUCHI, Osaka-shi (JP); Toshio HATA, Osaka-shi (JP)

(21) Appl. No.: 14/760,512

(22) PCT Filed: Dec. 20, 2013
(86) PCT No.: PCT/JP2013/084308

§ 371 Date: Jul. 13, 2015

(30) Foreign Application Priority Data
Jan. 24, 2013 (JP) 2013-011397

(51) Int. Cl. F21V 7/22; F21V 17/02; F21V 15/00; F21V 7/00; F21V 7/04

(52) U.S. Cl. CPC F21V 7/22; F21V 7/0066; F21V 7/04; F21V 15/00; F21V 17/02

(57) ABSTRACT

A reflector (10) according to one aspect of the present invention includes a metal reflector base (3) having a three-dimensional surface, and a ceramic layer (4) having optical reflectivity, which is formed on the three-dimensional surface.

### TECHNICAL FIELD

The present invention relates to an optical member and a reflector, and particularly relates to a light-emitting device including the optical member and the reflector as well as a lighting device including the light-emitting device.

### BACKGROUND ART

A light-emitting device including a light-emitting element and a member having optical reflectivity that reflects light emitted from the light-emitting element to a desired direction in order to improve light usage efficiency thereof has been known.

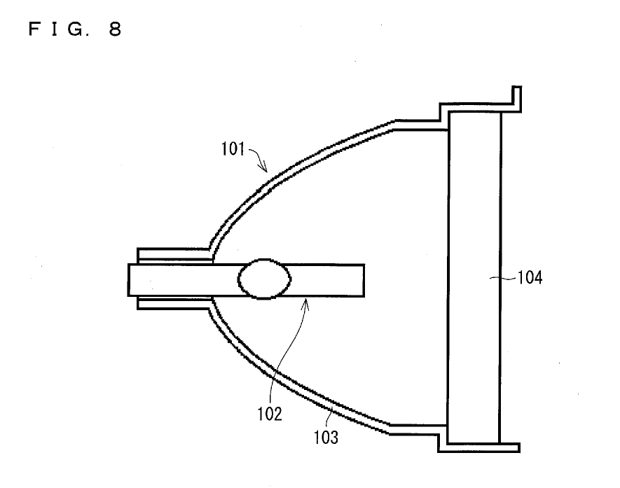

For example, FIG. 8 illustrates a light source lamp part of a light source lamp unit disclosed in PTL 1. A light source lamp part 101 in FIG. 8 includes a high-pressure discharge lamp 102, a metal reflector 103 to which the high-pressure discharge lamp 102 is fixed, and an explosion-proof front glass 104 for closing a front opening of the metal reflector 103. The metal reflector 103 has a concave reflecting surface, and light from the high-pressure discharge lamp 102 constituted by, for example, a high pressure mercury lamp is reflected by the concave reflecting surface.

### CITATION LIST

### Patent Literature

PTL 1: Japanese Unexamined Patent Application Publication “Tokkai No. 2008-98086 (Publication date: Apr. 24, 2008)”

### SUMMARY OF INVENTION

1. Technical Problem

However, corrosion resistance is not sufficient with a configuration of PTL 1. PTL 1 describes an invention assuming that the light source lamp unit including the light source lamp part 101 in FIG. 8 is mounted on a projection display device such as a liquid crystal projector. Generally, however, there are many places where a light-emitting device is to be installed not only indoors but also outdoors. An example thereof includes an outdoor lamp. The outdoor lamp is exposed to sunlight, and rain and wind, or exposed to exhaust gas of cars and the like. The same is also applied to a headlamp of a car. For the light-emitting device which is installed in such an environment, corrosion of a member is concerned. For example, a light reflecting surface is likely to corrode, and the corrosion of the light reflecting surface decreases optical reflectance and causes decrease in the light usage efficiency of the light-emitting device. That is, the light-emitting device needs to have excellent corrosion resistance. PTL 1 includes the explosion-proof front glass 104, but the corrosion resistance of the concave reflecting surface of the metal reflector 103 is insufficient.

Thus, the present invention has been made in view of the problem described above, and an object thereof is to provide an optical member, a reflector, a light-emitting device, and a lighting device capable of taking advantages of ceramics such as corrosion resistance of a ceramic while keeping an advantage of a metal base that is capable of being processed to a three-dimensional shape easily.

2. Solution to Problem

In order to solve the aforementioned problem, an optical member according to the present invention includes a metal base having a three-dimensional surface; and a ceramic layer having optical reflectivity that is formed on at least a part of the three-dimensional surface.

Moreover, in order to solve the aforementioned problem, a reflector according to the present invention includes a metal reflector base that has an inner peripheral surface to which a light-emitting element is fixed at a center of an optical axis; and a ceramic layer having optical reflectivity that is formed on at least a part of a surface

Moreover, in order to solve the aforementioned problem, a light-emitting device according to the present invention includes the reflector described above; and a light-emitting element.

Moreover, in order to solve the aforementioned problem, a lighting device according to the present invention includes the light-emitting device described above.

3. Advantageous Effects of Invention

According to the present invention, an effect is obtained that it is possible to provide an optical member, a reflector, a light-emitting device, and a lighting device capable of taking advantages of ceramics such as corrosion resistance of a ceramic while keeping an advantage of a metal base that is capable of being processed to a three-dimensional shape easily.

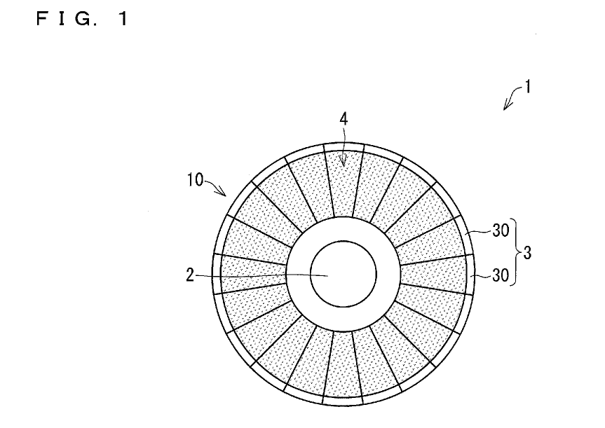

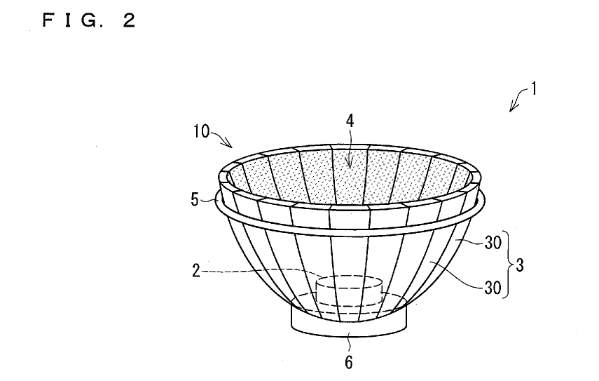

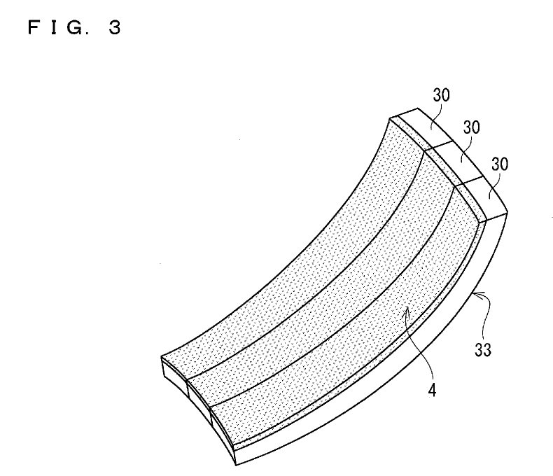

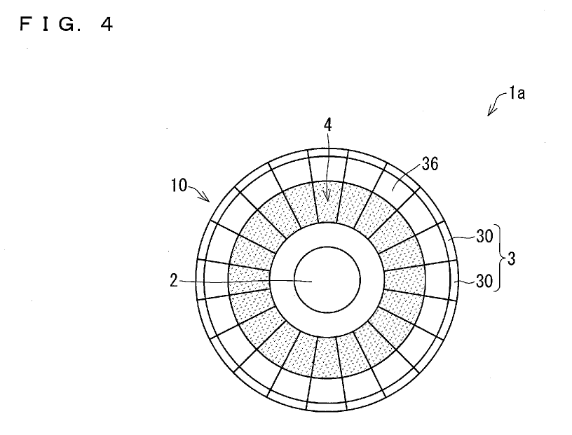

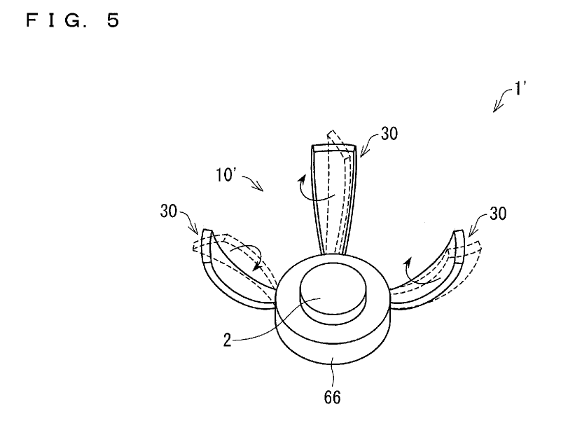

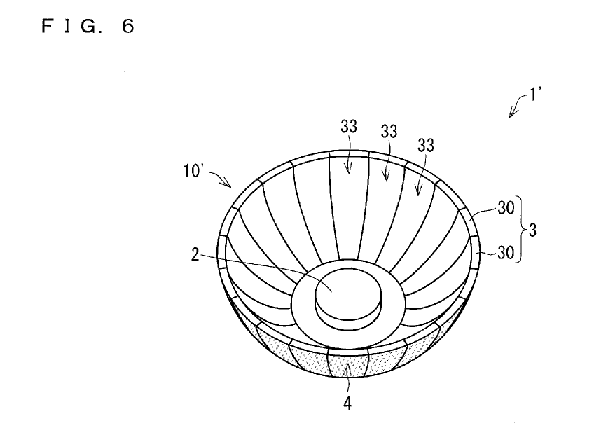

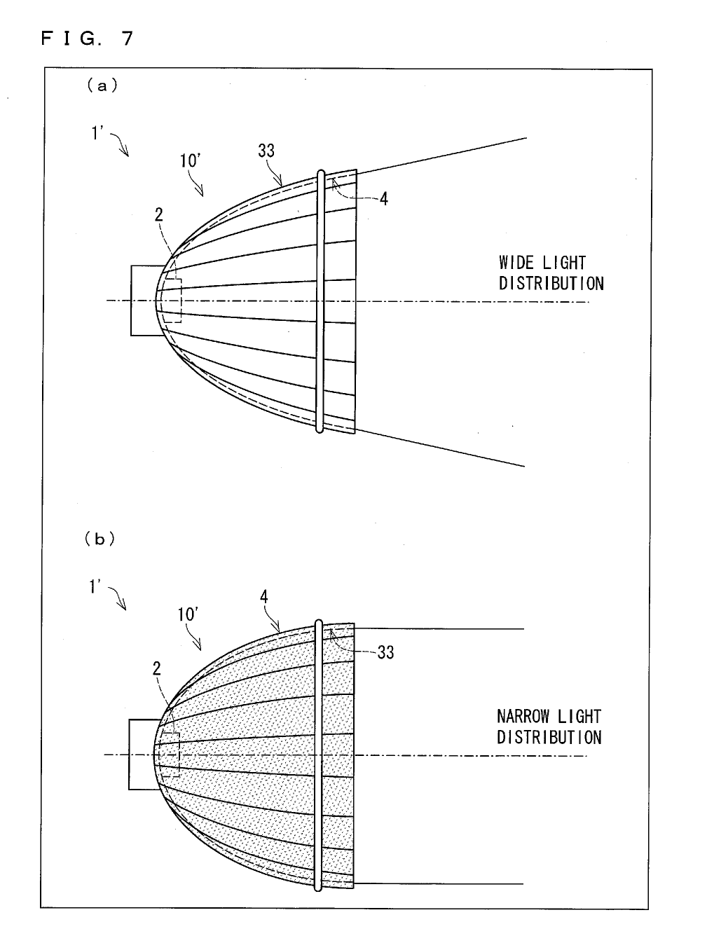

### BRIEF DESCRIPTION OF DRAWINGS

[FIG. 1] FIG. 1 is a top view illustrating a configuration of a light-emitting device including a reflector which is one embodiment of an optical member and a reflector according to the present invention;

[FIG. 2] FIG. 2 is a side view of the light-emitting device illustrated in FIG. 1;

[FIG. 3] FIG. 3 is a view illustrating a configuration of a part of the reflector included in the light-emitting device illustrated in FIG. 1;

[FIG. 4] FIG. 4 is a top view illustrating a configuration of a light-emitting device including a reflector of a modified example of the optical member and the reflector according to the present invention;

[FIG. 5] FIG. 5 is a top view illustrating a configuration of a light-emitting device including a reflector which is another embodiment of the optical member and the reflector according to the present invention;

[FIG. 6] FIG. 6 is a view in which light distribution ranges of the light-emitting device illustrated in FIG. 1 and the light-emitting device illustrated in FIG. 3 are compared;

[FIG. 7] FIG. 7 is a view specifically explaining the reflector included in the light-emitting device illustrated in FIG. 3; and

[FIG. 8] FIG. 8 is a view illustrating a configuration of the related art.

### DESCRIPTION OF EMBODIMENTS

### Embodiment 1

One embodiment of an optical member and a reflector according to the present invention is described below by using FIG. 1 to FIG. 3.

The reflector (optical member) according to the present embodiment is included in a light-emitting device illustrated in FIG. 1, and caused to reflect light of a light-emitting element described below. By including the reflector, light which is emitted from the light-emitting element and advances in a direction different from a desired direction is able to be guided to the desired direction by changing an optical path thereof by reflection, which significantly contributes to improvement of light usage efficiency as the light-emitting device.

Thus, an example of the light-emitting device including the reflector according to the present embodiment is described below.

FIG. 1 is a top view illustrating a configuration of the light-emitting device including the reflector which is one embodiment of the optical member and the reflector according to the present invention. A light-emitting device 1 of the present embodiment illustrated in FIG. 1 includes a light-emitting element 2 and a reflector 10.

The light-emitting element 2 is not particularly limited and a conventionally well-known light-emitting element is able to be adopted. For example, a semiconductor light-emitting element such as an LED (light emitting diode) is usable. The light-emitting element 2 is connected to a power source circuit by electrical connection means (not shown). Note that, a plurality of light-emitting elements 2 may be mounted at predetermined positions on a surface of the reflector 10, at which a predetermined light-emitting amount is able to be satisfied.

The light-emitting element 2 is arranged at a position at which a peripheral thereof is surrounded by the reflector 10. In other words, the light-emitting element 2 is arranged at a center of an optical axis of a concave surface (inner peripheral surface) formed by the reflector 10. Note that, the light-emitting element 2 and the reflector 10 may be jointed directly or coupled indirectly through some kind of member.

The reflector 10 has a reflector base 3 (base) composed of a plurality of metal plates 30 and a ceramic layer 4 as illustrated in FIG. 1.

The reflector base 3 is a base of the reflector 10 and is a concave-shaped structure having an external form of a substantially hemisphere shape. The light-emitting element 2 is arranged at a center portion of an inner-side surface (concave surface) of the concave-shaped structure, that is, a position corresponding to a pole of a hemisphere.

The reflector base 3 is composed of the plurality of metal plates 30. As illustrated in FIG. 1, a circumference of a circular opening end of the reflector base 3 is composed of the plurality of metal plates 30 being arrayed.

Each of the metal plates 30 is a long and narrow plate-shaped member which extends from a first end part on a side of a center portion of the reflector 3 where the light-emitting element 2 is arranged to a second end part on a side of the opening end of the reflector base 3. Each of the metal plates 30 is curved and has a three-dimensional surface. By arraying the plurality of metal plates 30 so that end parts of the respective metal plates 30 along a longitudinal direction contact with each other, the concave-shaped structure which has the substantially hemisphere shape described above is able to be formed.

Each of the metal plates 30 preferably has high thermal conductivity. Thus, even if the light-emitting element 2 is one which generates heat, the generated heat is able to be radiated efficiently. A substrate made of metal such as, for example, aluminum or copper is usable for each of the metal plates 30. In particular, aluminum or copper is preferably adopted because of being inexpensive, easy to be processed, strong against atmospheric humidity and the like.

Here, FIG. 2 is a side view of the light-emitting device 1 of the present embodiment. The concave-shaped structure of the hemisphere shape, which is formed with the plurality of metal plates 30 being adjacent to each other as described above, is able to maintain the hemisphere shape surely using a support belt 5 illustrated in FIG. 2. The support belt 5 supports a vicinity of the second end part on the side of the opening end of the reflector base 3 in each of the metal plates 30. Some of the metal plates 30 have a hole into which a projection part provided in the support belt 5 is able to be inserted in the vicinity of the second end parts thereof. By inserting the projection part into the hole, the support belt is able to support the plurality of metal plates 30. On the other hand, the first end part on the side of the center portion of the reflector base 3 in each of the metal plates 30 may be fixed by using a fixation member 6 (FIG. 2). Note that, the fixation member may be a part of the light-emitting element 2.

In the present embodiment, the shape of the reflector base 3 is the hemisphere shape and the concave surface is formed with a curved surface. Thus, a reflection direction of the light-emitting element is adjusted (light distribution is controlled) and illumination is made uniform in a peripheral direction. Accordingly, since it is possible to improve the illumination of the light-emitting device, equipment efficiency is increased and it becomes possible to reduce an energy usage amount by suppressing power consumption to be low. However, the concave surface is not limited thereto and may be an inclination surface which is not curved.

Moreover, though both of an outer-side shape and an inner-side shape of the reflector base 3 are the hemisphere shapes in the present embodiment, the present invention is not limited thereto. For example, the shape of the reflector base 3 may be other polygons such as a triangle, a square, a pentagon, a hexagon, or an octagon, may be a circle or an ellipse, or may be other shapes. Further, both of an outline structure (shape) of the reflector base 3 and an inner-surface structure of the reflector base 3 have the hemisphere shape in the present embodiment, but are not necessarily have the same shape.

The reflector base 3 is formed by arraying the plurality of metal plates 30 in the present embodiment. However, for example, if one plate member having flexibility is used and the plate member has a bottom-surface member and a plurality of side pieces which extend radially from an outer peripheral of the bottom-surface member with the bottom-surface member as a center, it is also possible to realize the reflector base 3 having a shape equivalent to those illustrated in FIG. 1 and FIG. 2 by curving one surface of each of the side pieces so as to face another side piece.

Next, the ceramic layer 4 is a layer which covers a concave-shaped surface that is an inner surface of the reflector base 3 constituting the concave-shaped structure of the hemisphere shape. That is, a shape of a surface of the ceramic layer 4 (surface constituting an inner-side surface of the reflector 10) is also same as that of the concave-shaped structure of the reflector base 3.

Here, a perspective view of the metal plates 30 and the ceramic layer 4 is illustrated by using FIG. 3.

The ceramic layer 4 is formed on a part of front and back surfaces (three-dimensional surfaces) of the metal plates 30, that is, only on a surface constituting the inner-side surface of the reflector base 3.

The ceramic layer 4 is made of a ceramic having corrosion resistance and high optical reflectivity. As long as being such a ceramic, a ceramic is not particularly limited and, for example, a zirconia-based ceramic is able to be adopted. In particular, when the metal plates 30 are made of aluminum having a low melting point, by using the zirconia-based ceramic which is sintered at a sintering temperature lower than the melting point of aluminum, there is an effect that the ceramic is able to be sintered on the base surface while keeping the shape of the base.

An optical reflectance of the ceramic layer 4 is desired to be at a same level or slightly higher compared to the optical reflectance of the reflector base 3 (metal plates 30). The ceramic layer 4 has a property of scattering incident light as light reflective properties thereof. That is, a term of the optical reflectivity in the description of the present application includes not only light reflection but also light scattering (scattered reflection).

Thickness of the ceramic layer 4 is not particularly limited, but is preferably set to 2 μm or more and 200 μm or less because the layer thickness does not become uniform in the curved reflector having a large area in the case of being 2 μm or less and roughness is caused on the surface of the applied ceramic layer and expected scattering is not able to be achieved in the case of being 200 μm or more.

Note that, thickness of the reflector base 3 (metal plates 30) is not particularly limited, but is preferably set to, for example, 500 μm. In addition, the thickness of the reflector base 3 (metal plates 30) may not be uniform. An opening diameter of the reflector 10 on a light emission side is not particularly limited, but is able to be set to, for example, 11 cm, and is able to be set to, for example, from 80 cm to 180 cm in the case of a reflector for downlight, for example.

A method for manufacturing the light-emitting device 1 of the present embodiment includes a step of forming the ceramic layer on one-side surfaces of the metal plates 30 as one of the manufacturing steps of the reflector 10. At the step, one example of a method for forming the ceramic layer includes a method for forming the ceramic layer by dipping the metal plates 30 in a ceramic coating tank.

Here, the ceramic layer may be formed on both surfaces of the metal plates 30. Therefore, when the dipping method described above is adopted, the ceramic layer may be formed also on back surfaces 33 of the metal plates 30 (FIG. 1 and FIG. 2) to which light of the light-emitting element 2 does not reach.

Note that, the method for forming the ceramic layer is not limited to one by the dipping method, and a method for applying ceramic coating to the metal plates 30 by using spraying is also included.

As described above, the light-emitting device 1 of the present embodiment is able to guide light emitted from the light-emitting element 2 to the opening end from a center portion thereof to be emitted from the light-emitting device 1 with high optical reflectivity that the ceramic layer 4 has. In addition, with corrosion resistance that the ceramic layer 4 has, a light reflecting surface of the reflector 10 (surface of the ceramic layer 4) is difficult to corrode and the optical reflectivity is able to be maintained by suppressing degradation of light reflective properties associated with the corrosion. Thus, the light-emitting device 1 of the present embodiment has the light usage efficiency which is difficult to be reduced and is able to keep the light usage efficiency for a long period.

Moreover, it is possible to provide an optical part capable of taking an advantage of ceramics such as corrosion resistance of a ceramic while keeping an advantage of a metal base capable of being processed to a three-dimensional shape easily.

When installing a reflector in a light-emitting device composed of a metal substrate, it has been difficult to use a metal reflector because of necessity of securing insulation. There is an advantage of easily securing insulation by applying ceramic coating to the reflector like in the present invention.

Note that, an explosion-proof front glass (not shown) may be arranged on the light emission side in the light-emitting device of the present embodiment.

Here, the substrate as a member that constitutes the light-emitting element 2 is made of an insulating substrate or a metal substrate (aluminum, copper, or the like).

Further, as one embodiment of a lighting device according to the present invention, an aspect including the light-emitting device 1 described above is included. As the lighting device, a spotlight, a downlight, and the like are included.

### Modified Example

Though the ceramic layer is formed entirely on one-side surfaces of the metal plates 30 as illustrated in FIG. 3 in the present embodiment, the present invention is not limited thereto. FIG. 4 is a view illustrating a modified example of the present embodiment, and is a top view illustrating a configuration of a light-emitting device la in the same manner as FIG. 1. In the light-emitting device la of the present modified example, as illustrated in FIG. 4, the ceramic layer 4 is formed only on a part of one-side surfaces of the metal plates 30. That is, a region where the ceramic layer 4 is formed and a region 36 where the metal plate 30 is exposed exist in the one-side surface.

More specifically, in the modified example illustrated in FIG. 4, there is the region where the ceramic layer is formed on a side of the aforementioned first end part of the one-side surface of the metal plate 30 and the metal plate 30 is exposed on a side of the aforementioned second end part thereof.

Here, a difference is provided between light reflective properties of the ceramic layer 4 and light reflective properties in the region 36 where the metal plate 30 is exposed. With such configuration, it is possible to provide the light-emitting device which realizes two types of light distribution characteristics.

Note that, it is possible to provide the light-emitting device which realizes desired necessary light distribution characteristics by changing a ceramic formation area. A formation position of the ceramic layer is not limited to the position illustrated in FIG. 4.

### Embodiment 2

Another embodiment of the present invention is described below based on FIG. 5 to FIG. 7. Note that, for convenience of description, same reference signs are assigned to members having same functions as those of members described in the aforementioned embodiment 1 and description thereof will be omitted.

In the embodiment 1 described above, the surface of the reflector 10 on the light-emitting element 2 side (the inner-side surface of the reflector) is constituted by the ceramic layer 4 as illustrated in FIG. 1 and FIG. 2. With the configuration of the embodiment 1, the ceramic layer 4 is also able to be formed on front and back surfaces of the metal plates 30. On the other hand, in the present embodiment 2, such an aspect is provided that one in which the ceramic layer 4 is formed only on single sides of the metal plates 30 and the ceramic layer is not formed on the other sides thereof is adopted, and further, a case with the ceramic layer 4 and a case without the ceramic layer 4 on the surface of the reflector 10 on the light-emitting element 2 side (the inner-side surface of the reflector) are able to be switched. The present embodiment 2 is described below.

The present embodiment 2 is characterized in that each of the metal plates 30 includes a rotation mechanism 66 (mechanism) which rotates so as to turn over front and back surfaces. FIG. 5 is a view explaining the rotation mechanism. Note that, FIG. 5 illustrates only three metal plates 30 of the plurality of metal plates 30 constituting the reflector base 3 for convenience of description.

The present embodiment 2 has the rotation mechanism 66 as illustrated in FIG. 5. The rotation mechanism 66 rotates the metal plates 30 so that surfaces which have faced the light-emitting element 2 side face a side opposite thereto and surfaces which have faced an outer side face the light-emitting element 2 side in a state of supporting first end parts in the metal plates 30, which are close to the light-emitting element 2, that is, in a state of not changing positions of the first end parts. The rotation mechanism 66 performs the rotation for all the metal plates 30. By applying the rotation operation to the configuration illustrated in FIG. 1 where the inner-side surface of the reflector 10 is the ceramic layer 4, it is possible to turn into a state, after the rotation operation, where the inner-side surface of the reflector 10 is constituted by the surfaces 33 of the metal plates 30, in which no ceramic layer is formed, as illustrated in FIG. 6.

That is, the rotation mechanism 66 includes holding means (not shown) of holding the first end parts in the metal plates 30, which are close to the light-emitting element 2, and rotation means (not shown) of driving the holding means to rotate the metal plates 30 as described above.

As described above, a light-emitting device 1′ of the present embodiment 2 is a light-emitting device with a configuration capable of switching the inner-side surface of the reflector 10 between a surface which is composed of the ceramic layer 4 and a surface which is not composed of the ceramic layer 4. Note that, a switching method is not limited to rotation.

As described above, light reflected on the surface of the ceramic layer 4 has low directivity compared to light reflected on the surfaces (surfaces 33) of the metal plates 30. Here, FIG. 7(a) schematically illustrates a light distribution range of light emitted from the light-emitting device in a state where the inner-side surface of the reflector 10 is constituted by the surface of the ceramic layer 4 in the present embodiment 2, which is same as in the light-emitting device 1 of the embodiment 1 (FIG. 1). On the other hand, FIG. 7(b) schematically illustrates a light distribution range of light emitted from the light-emitting device 1′ in a state illustrated in FIG. 6 where the inner-side surface of the reflector 10 is constituted by a surface which is not the ceramic layer in the present embodiment 2, that is, by the surfaces 33 of the metal plates 30 in the present embodiment 2. The two light-emitting devices illustrated in FIG. 7 have a same configuration except for having different inner-side surfaces of the reflector 10. When comparing the two light-emitting devices illustrated in FIG. 7, it is found that the light distribution range becomes wider in a case where the inner-side surface of the reflector 10 is constituted by the surface of the ceramic layer 4 than in a case of not being constituted by the surface of the ceramic layer 4. A wide light distribution range makes it possible to light a wide range. On the other hand, when light is reflected by using the surface on which no ceramic layer is formed in the reflector, the light distribution range is narrow, which is suitable for a spotlight.

That is, in the present embodiment 2, the state of FIG. 7(a) and the state of FIG. 7(b) are able to be switched by including the rotation mechanism 66 described above.

When rotation operation that is performed by using the rotation mechanism 66 as illustrated in FIG. 5 is performed, the rotation operation is performed in a state where support by the support belt 5, which is described in the embodiment 1 above, is released. This makes it possible to avoid that the adjacent metal plates 30 contact with each other at the time of rotation.

Note that, an aspect is not limited to the aspect in which an area of the light distribution range is switched between a wide range and a narrow range with the mechanism illustrated in FIG. 5.

In this manner, according to the present embodiment 2, it is possible to switch the area of the light distribution range between the wide range and the narrow range.

Note that, it is also possible to manually rotate the surface of the reflector 10, on which the ceramic layer 4 is formed, and the surface (surfaces 33 of the metal plates 30) on which the ceramic layer 4 is not formed. Moreover, each surface is able to rotate independently. By rotating one surface independently, it is possible to change a ceramic coated area in accordance with required light distribution performance.

### SUMMARY

An optical part (reflector 10) according to an aspect 1 of the present invention includes a metal base (reflector base 3) having a three-dimensional surface; and a ceramic layer 4 having optical reflectivity, which is formed on at least a part of the three-dimensional surface (inner peripheral side of the reflector base 3, for example).

With the aforementioned configuration, since the ceramic layer 4 covers at least a part of the three-dimensional surface, it is possible to realize corrosion resistance of the part covered by the ceramic layer 4, and, also as an optical part, it is possible to enhance corrosion resistance compared to an optical part in which no ceramic layer is formed.

Moreover, by forming the ceramic layer 4 on a light reflecting surface of the optical part, it is possible to enhance corrosion resistance of the light reflecting surface and hence suppress decrease in optical reflectance associated with the corrosion. Accordingly, it is possible to keep reflectivity of the optical part (reflector 10).

That is, with the configuration of the optical part according to the present invention, it is possible to realize the optical part capable of taking an advantage of ceramics such as corrosion resistance of a ceramic while keeping an advantage of a metal base capable of being processed to a three-dimensional shape easily.

In the optical part (reflector 10) according to an aspect 2 of the present invention, the base (reflector base 3) may be made of aluminum in the aforementioned aspect 1.

With the aforementioned configuration, it is possible to configure the base (reflector base 3) with inexpensive aluminum which is easy to be processed, suppress manufacturing cost of the optical part (reflector 10), and realize easiness of manufacturing.

In the optical part (reflector 10) according to an aspect 3 of the present invention, the base may be made of copper in the aforementioned aspect 1.

With the aforementioned configuration, it is possible to configure the base (reflector base 3) with inexpensive copper which is easy to be processed, suppress manufacturing cost of the optical part (reflector 10), and realize easiness of manufacturing.

In the optical part (reflector 10) according to an aspect 4 of the present invention, the ceramic layer 4 may be made of a zirconia-based ceramic in the aforementioned aspect 1.

By configuring the ceramic layer 4 with the zirconia-based ceramic, it is possible to provide the optical part (reflector 10) which is excellent in corrosion resistance and optical reflectivity.

In the optical part according to an aspect 5 of the present invention, the ceramic layer 4 may be formed only on a part of the three-dimensional surface of the base (reflector base 3) in the aforementioned aspect 1.

In the optical part according to an aspect 6 of the present invention, the ceramic layer 4 may be a layer that is formed by applying ceramic coating to the base (reflector base 3) by spraying in the aforementioned aspect 1.

With the aforementioned configuration, it is possible to form the ceramic layer 4 on the three-dimensional surface of the base (reflector base 3) easily.

In the optical part according to an aspect 7 of the present invention, the ceramic layer may be a layer that is formed by dipping the base in a ceramic coating tank in the aforementioned aspect 1.

With the aforementioned configuration, it is possible to form the ceramic layer 4 on the three-dimensional surface of the base (reflector base 3) easily.

A reflector 10 according to an aspect 8 of the present invention includes: a metal reflector base 3 that has an inner peripheral surface to which a light-emitting element is fixed at a center of an optical axis; and a ceramic layer 4 having optical reflectivity, which is formed on at least a part of a surface of the reflector base 3 (the aforementioned inner peripheral surface, for example).

With the aforementioned configuration, since the ceramic layer 4 covers at least a part of the three-dimensional surface, it is possible to realize corrosion resistance of the part covered by the ceramic layer 4, and, also as a reflector, it is possible to enhance corrosion resistance compared to a reflector in which no ceramic layer is formed.

By forming the ceramic layer 4 on a light reflecting surface of the reflector 10, it is possible to enhance corrosion resistance of the light reflecting surface and hence suppress decrease in optical reflectance associated with the corrosion. Accordingly, it is possible to keep reflectivity of the reflector 10.

That is, with the configuration of the reflector according to the present invention, it is possible to realize the reflector capable of taking an advantage of ceramics such as corrosion resistance of a ceramic while keeping an advantage of a metal base capable of being processed to a three-dimensional shape easily.

The reflector according to an aspect 9 of the present invention (reflector 10′ of the embodiment 2) includes the metal reflector base 3 that has the inner peripheral surface (inner-side surface of the reflector 10′ of the embodiment 2) having optical reflectivity, to which the light-emitting element is fixed at the center of the optical axis. The reflector base 3 is composed of a plurality of metal plates 30 to configure the inner peripheral surface (inner-side surface of the reflector 10′ of the embodiment 2) by single sides of the plurality of metal plates 30, in which each of the plurality of metal plates 30 has a front surface on which the ceramic layer 4 having optical reflectivity is formed and a back surface (surface 33) on which the ceramic layer is not formed. The reflector (reflector 10′ of the embodiment 2) further includes a mechanism (rotation mechanism 66) by which each of the plurality of metal plates 30 is movable (rotates) to make a surface constituting the inner peripheral surface (inner-side surface of the reflector 10′ of the embodiment 2) movable (reversed) with the front surface and the back surface.

With the aforementioned configuration, by including the aforementioned mechanism (rotation mechanism 66), it is possible to switch a case where the ceramic layer serves as the light reflecting surface and a case the ceramic layer does not serve as the light reflecting surface. Since the ceramic layer lowers directivity of incident light, by switching the light reflecting surface in this manner, it is possible to switch an area of a light distribution range between a wide range and a narrow range.

Moreover, with the light reflecting surface configured with the ceramic layer, it is possible to enhance corrosion resistance by the ceramic layer and hence suppress decrease in an optical reflectance associated with the corrosion. Accordingly, it is possible to keep optical reflectivity of the reflector 10.

In the reflector according to an aspect 10 of the present invention (reflector 10 of the embodiment 1 and reflector 10′ of the embodiment 2), the reflector base 3 may be made of aluminum in the aforementioned aspect 8 or 9.

With the aforementioned configuration, it is possible to configure the base (reflector base 3) with inexpensive aluminum which is easy to be processed, suppress manufacturing cost of the reflector (reflector 10 of the embodiment 1 and reflector 10′ of the embodiment 2), and realize easiness of manufacturing.

In the reflector according to an aspect 11 of the present invention (reflector 10 of the embodiment 1 and reflector 10′ of the embodiment 2), the reflector base 3 may be made of copper in the aforementioned aspect 8 or 9.

With the aforementioned configuration, it is possible to configure the reflector base 3 with inexpensive copper which is easy to be processed, suppress manufacturing cost of the reflector (reflector 10 of the embodiment 1 and reflector 10′ of the embodiment 2), and realize easiness of manufacturing.

In the reflector according to an aspect 12 of the present invention (reflector 10 of the embodiment 1 and reflector 10′ of the embodiment 2), the ceramic layer may be made of a zirconia-based ceramic in the aforementioned aspect 8 or 9.

By configuring the ceramic layer 4 with the zirconia-based ceramic, it is possible to provide the reflector (reflector 10 of the embodiment 1 and reflector 10′ of the embodiment 2) which is excellent in corrosion resistance and optical reflectivity.

In the reflector according to an aspect 13 of the present invention (reflector 10 of the embodiment 1 and reflector 10′ of the embodiment 2), the ceramic layer may be formed only on a part of the inner peripheral surface in the aforementioned aspect 8 or 9.

In the reflector according to an aspect 14 of the present invention (reflector 10 of the embodiment 1 and reflector 10′ of the embodiment 2), the ceramic layer may be a layer that is formed by applying ceramic coating to the reflector base 3 by spraying in the aforementioned aspect 8 or 9.

With the aforementioned configuration, it is possible to form the ceramic layer 4 on the surface of the reflector base 3 easily.

In the reflector according to an aspect 15 of the present invention (reflector 10 of the embodiment 1 and reflector 10′ of the embodiment 2), the ceramic layer may be a layer that is formed by dipping the reflector base 3 in a ceramic coating tank in the aforementioned aspect 8 or 9.

With the aforementioned configuration, it is possible to form the ceramic layer 4 on the surface of the reflector base 3 easily.

A light-emitting device 1, 1a, 1′ according to an aspect 16 of the present invention is characterized by including the reflector described above (reflector 10 of the embodiment 1 and reflector 10′ of the embodiment 2) and a light-emitting element 2.

A lighting device according to an aspect 16 of the present invention is characterized by including the light-emitting device 1, 1a, 1′ described above. Examples of the lighting device include a spotlight and a downlight.

The present invention is not limited to the respective embodiments described above, various modifications are possible in the scope indicated in Claims, and an embodiment acquired by combining appropriately technical means each disclosed in a different embodiment is also included in the technical scope of the present invention. Further, by combining technical means each disclosed in each embodiment, a new technical feature is able to be formed.

### INDUSTRIAL APPLICABILITY

The present invention is able to be utilized for a light-emitting device, and particularly is able to be utilized as a light-emitting device for a spotlight preferably.

### REFERENCE SIGNS LIST

1, 1a, 1′ light-emitting device

2 light-emitting element

3 reflector base (base)

4 ceramic layer

5 support belt

6 fixation member

10, 10′ reflector (optical part)

30 metal plate

33 back surface

36 region

66 rotation mechanism (mechanism)

1-17. (canceled)

18. An optical part, comprising:
a metal base having a three-dimensional surface; and
a ceramic layer having optical reflectivity, which is formed on at least a part of the three-dimensional surface; wherein
the base is made of aluminum, and
the ceramic layer is made of a zirconia-based ceramic.

19. The optical part according to claim 18, wherein the ceramic layer is formed only on a part of the three-dimensional surface of the base.

20. The optical part according to claim 18, wherein the ceramic layer is a layer that is formed by applying ceramic coating to the base by spraying.

21. The optical part according to claim 18, wherein the ceramic layer is a layer that is formed by dipping the base in a ceramic coating tank.

22. A reflector, comprising:
a metal reflector base that has an inner peripheral surface to which a light-emitting element is fixed at a center of an optical axis; and
a ceramic layer having optical reflectivity, which is formed on at least a part of a surface of the reflector base; wherein
the reflector base is made of aluminum, and
the ceramic layer is made of a zirconia-based ceramic.

23. A reflector, comprising:
a metal reflector base that has an inner peripheral surface to which a light-emitting element is fixed at a center of an optical axis; and
a ceramic layer having optical reflectivity, which is formed on at least a part of a surface of the reflector base; wherein
the inner peripheral surface of the reflector base has optical reflectivity,
the reflector base is composed of a plurality of metal plates to form the inner peripheral surface by single sides of the plurality of metal plates,
each of the metal plates has a front surface on which the ceramic layer having optical reflectivity is formed and a back surface on which the ceramic layer is not formed, and
a mechanism by which each of the plurality of metal plates is movable to make a surface forming the inner peripheral surface movable to be the front surface or the back surface is further included.

24. The reflector according to claim 22, wherein the ceramic layer is formed only on a part of the inner peripheral surface.

25. The reflector according to claim 22, wherein the ceramic layer is a layer that is formed by applying ceramic coating to the reflector base by spraying.

26. The reflector according to claim 22, wherein the ceramic layer is a layer that is formed by dipping the reflector base in a ceramic coating tank.

27. A light-emitting device, comprising:
the reflector according to claim 22, and
a light-emitting element.

28. A lighting device having the light-emitting device according to claim 27.

29. The reflector according to claim 23, wherein the ceramic layer is a layer that is formed by applying ceramic coating to the reflector base by spraying.

30. The reflector according to claim 23, wherein the ceramic layer is a layer that is formed by dipping the reflector base in a ceramic coating tank.

31. A light-emitting device, comprising:
the reflector according to claim 23, and
a light-emitting element.
